(19) United States
(12) Patent Application Publication
(10) Pub. No.: US 2006/0072675 A1
(43) Pub. Date: Apr. 6, 2006

(54) Method for encoding and decoding video signals

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/231,883

(22) Filed: Sep. 22, 2005

Related U.S. Application Data
(60) Provisional application No. 60/612,179, filed on Sep. 23, 2004.

(30) Foreign Application Priority Data
Mar. 11, 2005 (KR) 10-2005-0020409

(51) Int. Cl. H04N 11/02; H04N 11/04; H04N 5/14; H04N 9/64; H04N 7/12; H04B 1/66

(52) U.S. Cl. 375/240.25; 348/700

(57) ABSTRACT

In one embodiment, a frame in a current frame interval is decoded based on at least one frame in at least one adjacent frame interval. The adjacent frame interval is adjacent to the current frame interval. For example, the adjacent frame interval may be a previous frame interval and/or a subsequent frame interval. Also, the frame of the adjacent interval being used in the encoding process may be an H frame and/or an L frame.

### DOMESTIC PRIORITY INFORMATION

This application claims priority under 35 U.S.C. §119 on U.S. provisional application 60/612,179, filed Sep. 23, 2004; the entire contents of which are hereby incorporated by reference.

### BACKGROUND OF THE INVENTION

1. Field of the Invention

The present invention relates to a method for encoding and decoding video signals.

2. Description of the Related Art

A number of standards have been suggested for digitizing video signals. One well-known standard is MPEG, which has been adopted for recording movie content, etc., on recording media such as DVDs and is now in widespread use. Another standard is H.264, which is expected to be used as a standard for high-quality TV broadcast signals in the future.

While TV broadcast signals require high bandwidth, it is difficult to allocate such high bandwidth for the type of wireless transmissions/receptions performed by mobile phones and notebook computers, for example. Thus, video compression standards for use with mobile devices must have high video signal compression efficiencies.

Such mobile devices have a variety of processing and presentation capabilities so that a variety of compressed video data forms must be prepared. This indicates that the same video source must be provided in a variety of forms corresponding to a variety of combinations of variables such as the number of frames transmitted per second, resolution, the number of bits per pixel, etc. This imposes a great burden on content providers.

In view of the above, content providers prepare high-bitrate compressed video data for each source video and perform, when receiving a request from a mobile device, a process of decoding compressed video and encoding it back into video data suited to the video processing capabilities of the mobile device before providing the requested video to the mobile device. However, this method entails a transcoding procedure including decoding and encoding processes, and causes some time delay in providing the requested data to the mobile device. The transcoding procedure also requires complex hardware and algorithms to cope with the wide variety of target encoding formats.

A Scalable Video Codec (SVC) has been developed in an attempt to overcome these problems. This scheme encodes video into a sequence of pictures with the highest image quality while ensuring that part of the encoded picture sequence (specifically, a partial sequence of frames intermittently selected from the total sequence of frames) can be used to represent the video with a low image quality.

Motion Compensated Temporal Filtering (MCTF) is an encoding scheme that has been suggested for use in the scalable video codec. However, the MCTF scheme requires a high compression efficiency (i.e., a high coding rate) for reducing the number of bits transmitted per second since it is highly likely that it will be applied to mobile communication where bandwidth is limited, as described above.

The conventional MCTF scheme encodes and decodes a video sequence using temporal image correlation in units of specific video frame intervals, each composed of a set number of video frames. In other words, the conventional MCTF scheme performs predictive and update operations, which will be described later, using only frames of the current frame interval. This causes image quality degradation at the boundaries of video frame intervals, thereby lowering the compression efficiency.

### SUMMARY OF THE INVENTION

The present invention relates to encoding and decoding a video signal by motion compensated temporal filtering.

In an example embodiment of a method of decoding a video signal by motion compensated temporal filtering (MCTF), a frame in a current frame interval is decoded based on at least one frame in at least one adjacent frame interval. The adjacent frame interval is adjacent to the current frame interval. For example, the adjacent frame interval may be a previous frame interval and/or a subsequent frame interval. Also, the frame of the adjacent interval used in the encoding process may be an H frame and/or an L frame.

In one embodiment, the decoder confirms, from information in the current frame interval, that the current frame interval was encoded using at least one frame from at least one adjacent frame interval, and performs the decoding if the confirming step confirms that the current frame interval was encoded using at least one frame from at least one adjacent frame interval.

In another embodiment, a frame in a current frame interval is decoded selectively based on at least one frame in at least one adjacent frame interval. The adjacent frame interval is adjacent to the current frame interval. For example, a frame of the adjacent frame interval is used in the decoding if no scene change takes place between the current frame interval and the adjacent frame interval.

In one example embodiment of a method of encoding a video signal by motion compensated temporal filtering (MCTF), a frame in a current frame interval is encoded based on at least one frame in at least one adjacent frame interval. The adjacent frame interval is adjacent to the current frame interval.

In another embodiment, a frame in a current frame interval is encoded selectively based on at least one frame in at least one adjacent frame interval. The adjacent frame interval is adjacent to the current frame interval. For example, a frame of the adjacent frame interval is used in the encoding if no scene change takes place between the current frame interval and the adjacent frame interval.

In a further embodiment of the present invention, information is added to an encoded current frame interval. The information may indicate whether at least one frame of an adjacent frame interval was used to encode the encoded current frame interval.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a video signal encoding device to which a scalable video signal compression method according to the present invention is applied;

FIG. 2 is a block diagram of a filter that performs video estimation/prediction and update operations in the MCTF encoder shown in FIG. 1;

FIG. 3 illustrates a general 5/3 tap MCTF encoding procedure;

FIG. 4 illustrates a 5/3 tap MCTF encoding procedure according to an embodiment of the present invention;

FIG. 5 illustrates an information field recorded in a header area of a group of frames generated by encoding a video frame interval according to an embodiment of the present invention;

FIG. 6 is a block diagram of a device for decoding a data stream, encoded by the device of FIG. 1, according to an example embodiments of the present invention; and

FIG. 7 is a block diagram of an inverse filter that performs inverse estimation/prediction and update operations in the MCTF decoder shown in FIG. 6 according to an example embodiments of the present invention.

### DETAILED DESCRIPTION OF EXAMPLE EMBODIMENTS

Example embodiments of the present invention will now be described in detail with reference to the accompanying drawings.

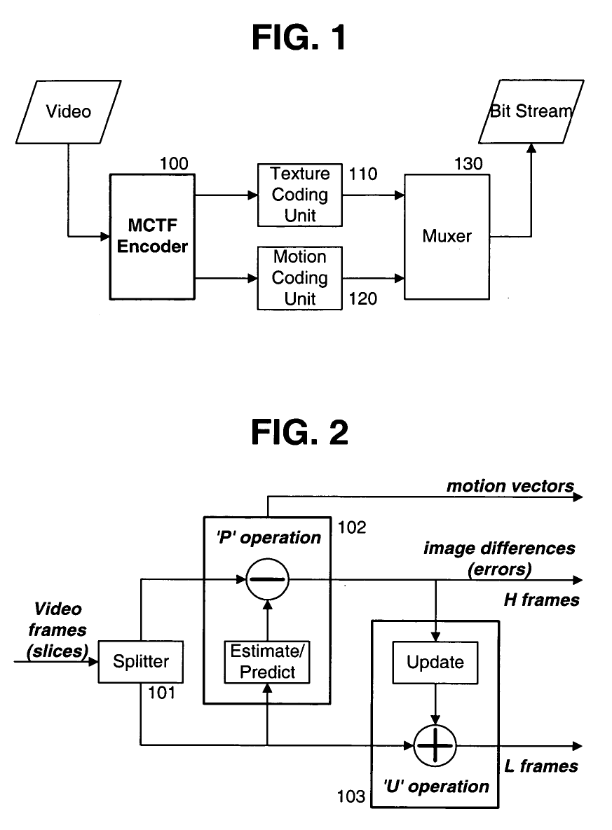

FIG. 1 is a block diagram of a video signal encoding device to which a scalable video signal compression method according to the present invention is applied.

The video signal encoding device shown in FIG. 1 comprises an MCTF encoder 100, a texture coding unit 110, a motion coding unit 120, and a muxer (or multiplexer) 130. The MCTF encoder 100 encodes an input video signal in units of macroblocks in an MCTF scheme, and generates suitable management information. The texture coding unit 110 converts data of encoded macroblocks into a compressed bitstream. The motion coding unit 120 codes motion vectors of image blocks obtained by the MCTF encoder 100 into a compressed bitstream according to a specified scheme. The muxer 130 encapsulates the output data of the texture coding unit 10 and the output vector data of the motion coding unit 120 into a set format. The muxer 130 multiplexes the encapsulated data into a set transmission format and outputs a data stream.

The MCTF encoder 100 performs motion estimation and prediction operations on each macroblock of a video frame, and also performs an update operation in such a manner that an image difference of the macroblock from a corresponding macroblock in a neighbor frame is added to the corresponding macroblock. FIG. 2 is a block diagram of a filter for carrying out these operations.

As shown in FIG. 2, the filter includes a splitter 101, an estimator/predictor 102, and an updater 103. The splitter 101 splits an input video frame sequence into earlier and later frames in pairs of successive frames (for example, into odd and even frames). The estimator/predictor 102 performs motion estimation and/or prediction operations on each macroblock in an arbitrary frame in the frame sequence. As described in more detail below, the estimator/predictor 102 searches for a reference block of each macroblock of the arbitrary frame in neighbor frames prior to and/or subsequent to the arbitrary frame and calculates an image difference (i.e., a pixel-to-pixel difference) of each macroblock from the reference block and a motion vector between each macroblock and the reference block. The updater 103 performs an update operation on a macroblock, whose reference block has been found, by normalizing the calculated image difference of the macroblock from the reference block and adding the normalized difference to the reference block. The operation carried out by the updater 103 is referred to as a ‘U’ operation, and a frame produced by the ‘U’ operation is referred to as an ‘L’ (low) frame.

The filter of FIG. 2 may perform its operations on a plurality of slices simultaneously and in parallel, which are produced by dividing a single frame, instead of performing its operations in units of frames. In the following description of the embodiments, the term ‘frame’ is used in a broad sense to include a ‘slice’.

The estimator/predictor 102 divides each of the input video frames into macroblocks of a set size. For each macroblock, the estimator/predictor 102 searches for a block, whose image is most similar to that of each divided macroblock, in neighbor frames prior to and/or subsequent to the input video frame. That is, the estimator/predictor 102 searches for a macroblock having the highest temporal correlation with the target macroblock. A block having the most similar image to a target image block has the smallest image difference from the target image block. The image difference of two image blocks is defined, for example, as the sum or average of pixel-to-pixel differences of the two image blocks. Accordingly, of macroblocks in a previous/next neighbor frame having a threshold pixel-to-pixel difference sum (or average) or less from a target macroblock in the current frame, a macroblock having the smallest difference sum (or average) from the target macroblock is referred to as a reference block. For each macroblock of a current frame, two reference blocks may be present in two frames prior to and subsequent to the current frame, or in one frame prior and one frame subsequent to the current frame.

If the reference block is found, the estimator/predictor 102 calculates and outputs a motion vector from the current block to the reference block, and also calculates and outputs differences of pixel values of the current block from pixel values of the reference block, which may be present in either the prior frame or the subsequent frame. Alternatively, the estimator/calculator 102 calculates and outputs differences of pixel values of the current block from average pixel values of two reference blocks, which may be present in the prior and subsequent frames.

Such an operation of the estimator/predictor 102 is referred to as a ‘P’ operation. A frame having an image difference, which the estimator/predictor 102 produces via the P operation, is referred to as an ‘H’ (high) frame since this frame has high frequency components of the video signal.

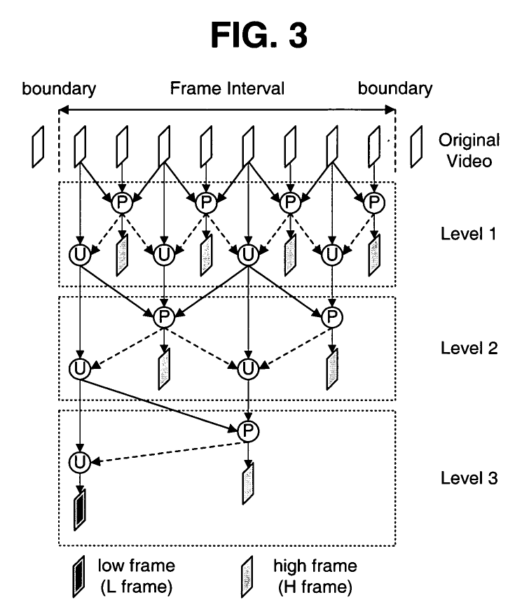

FIG. 3 illustrates a general 5/3 tap MCTF encoding procedure. The general MCTF encoder performs the ‘P’ and ‘U’ operations described above over a plurality of levels in units of specific video frame intervals. Specifically, the general MCTF encoder generates H and L frames of the first level by performing the ‘P’ and ‘U’ operations on a plurality of frames in a current video frame interval, and then generates H and L frames of the second level by repeating the ‘P’ and ‘U’ operations on the generated L frames of the first level via an estimator/predictor and an updater at a next serially-connected level (i.e., the second level) (not shown).

Since all L frames generated at each level are used to generate L and H frames of a next level, only H frames remain at every level other than the last level, where L frame(s) and H frame(s) remain.

The ‘P’ and ‘U’ operations may be repeated up to a level at such that one H frame and one L frame remains. The last level at which the ‘P’ and ‘U’ operations are performed is determined based on the total number of frames in the video frame interval. Optionally, the MCTF encoder may repeat the ‘P’ and ‘U’ operations up to a level at which two H frames and two L frames remain or up to its previous level.

In the example of FIG. 3, the MCTF encoder performs the ‘P’ and ‘U’ operations over three levels since each video frame interval is composed of 8 (=2³) frames. At the first level, the MCTF encoder generates 4 L frames and 4 H frames from the 8 frames; at the second level, the MCTF encoder generates 2 L frames and 2 H frames from the 4 L frames of the first level; and, at the last (i.e., 3rd) level, the MCTF encoder generates one L frame and one H frame from the 2 L frames of the second level. Consequently, the MCTF encoder generates 4 H frames of the first level, 2 H frames of the second level, and one L frame and one H frame of the third level.

The conventional MCTF encoding and decoding scheme, which uses only frames in the current video frame interval as shown in FIG. 3, is referred to as a closed structured MCTF scheme. In this closed structured MCTF scheme, it is difficult for L and H frames of each level generated at the boundaries of the video frame interval to correctly reflect L and H frames of its previous level since only the frames in the current video frame interval are used to generate the L and H frames of each level. Accordingly, if L and H frames encoded in the closed structured MCTF encoding scheme are decoded into their original frames, frames decoded at the boundaries of video frame intervals have a relatively low image quality.

The MCTF encoder according to the present invention, as described in detail below, performs encoding in units of specific video frame intervals while selectively performing the ‘P’ and ‘U’ operations additionally using frames of its adjacent intervals. This MCTF encoder may improve the image quality of decoded frames at the boundaries of frame intervals

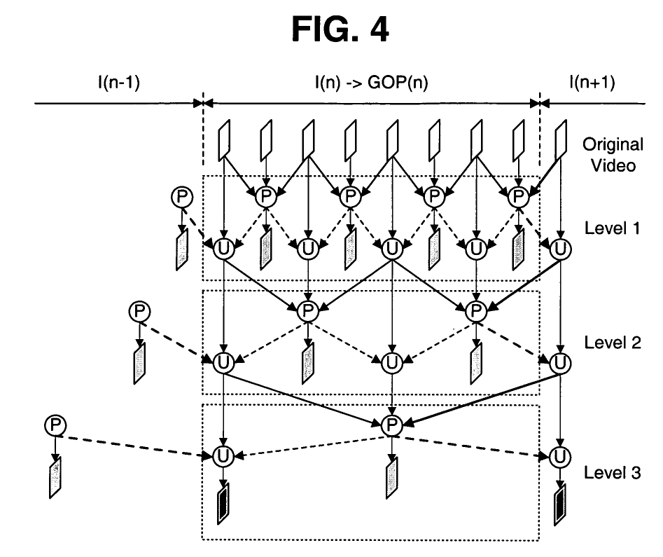

FIG. 4 illustrates a 5/3 tap MCTF encoding procedure according to an embodiment of the present invention. As will be understood by those skilled in the art, this MCTF encoding procedure may be used in the MCTF encoder 100 shown in FIG. 1.

As shown in FIG. 4, while performing ‘P’ and ‘U’ operations on frames in a current video frame interval I(n), an MCTF encoder 100 according to an embodiment of the present invention may additionally use an H frame of the same level generated in an encoding procedure of a previous frame interval I(n−1) to generate a first L frame of each level. In addition, while performing ‘P’ and ‘U’ operations on frames in the current video frame interval I(n), the MCTF encoder 100 may additionally use a first frame in a next frame interval I(n+1) to generate a last H frame of the first level in the current video frame interval I(n). Also, the MCTF encoder 100 may additionally use a first L frame generated at a previous level in the next frame interval I(n+1) to generate a last H frame in each of the second and subsequent levels.

The MCTF encoding and decoding scheme, which may additionally use frames of previous and next video frame intervals, is referred to as an open structured MCTF scheme. This open structured MCTF encoding/decoding reduces degradation in the image quality of frames at the boundaries of video frame intervals.

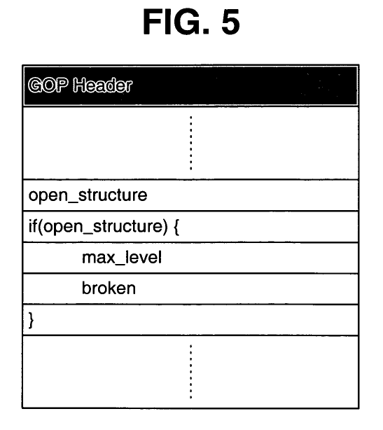

To inform the decoder of whether or not a data stream transmitted to the decoder has been encoded in the open structured MCTF scheme, the MCTF encoder 100 according to an embodiment of the present invention records an ‘open_structure’ information field at a specific position in a header of a group of frames (hereinafter, referred to as a group of pictures (GOP)) generated by encoding a video frame interval as shown in FIG. 5. Namely, an ‘open_structure’ information field is added to the encoded video signal. The MCTF encoder 100 records an appropriate activate indicator in the ‘open_structure’ information field if the current video frame interval is encoded in the open structured MCTF scheme, and records an appropriate deactivate indicator in the ‘open_structure’ information field if the current video frame interval is encoded in the open structured MCTF scheme.

In the case where the current video frame interval is encoded in the open structured MCTF scheme, the MCTF encoder may select the level of ‘P’ and ‘U’ operations up to which frames of adjacent frame intervals prior to and/or subsequent to the current frame interval are used. For example, the MCTF encoder 100 may not use frames of adjacent frame intervals when performing the ‘P’ and ‘U’ operations of the third and subsequent levels while using frames of adjacent frame intervals when performing the ‘P’ and ‘U’ operations of the first and second levels.

Thus, there is a need to define an information field informing the decoder of the level at which frames of adjacent frame intervals have been finally used when performing the ‘P’ and ‘U’ operations in the open structured MCTF scheme. Accordingly, the MCTF encoder 100 according to the present invention records a ‘max_level’ information field at a specific position in the header of a corresponding GOP as shown in FIG. 5. Namely, a ‘max_level’ information field is added to the encoded video signal. The ‘max_level’ information field is effective only when the ‘open_structure’ information field is activated.

In the case where a scene change occurs between the current and next video frame intervals, frames of the previous interval may be used but frames of the next interval should not be used when encoding/decoding the current video frame interval in the open structured MCTF scheme. Similarly, in the case where a scene change occurs between the current and previous video frame intervals, frames of the next interval may be used but frames of the previous interval should not be used when encoding/decoding the current video frame interval in the open structured MCTF scheme. A scene change may be caused by an editing operation performed in units of video frame intervals. Numerous well-known methods exist for detecting a scene change, any of which may be used in conjunction with the present invention.

To inform the decoder of whether or not frames of the next interval have been used when encoding the current video frame interval in the open structured MCTF scheme, the MCTF encoder 100 according to the present invention records a ‘broken’ information field at a specific position in the header of the current GOP as shown in FIG. 5. The MCTF encoder 100 deactivates the ‘broken’ information field when using frames of the next video frame interval. Otherwise, the MCTF encoder 100 activates the ‘broken’ information field.

The MCTF encoder 100 according to an embodiment of the present invention activates the ‘broken’ information field of the current GOP if an editing operation causes the current video frame interval to be followed by a different scene frame interval. The ‘broken’ information field is effective only when the ‘open_structure’ information field is activated.

Each of the ‘open_structure’ information field and the ‘broken’ information field may be set to be activated or deactivated using a 1-bit flag. Two or more bits are assigned to the ‘max_level’ information field since the value of the ‘max_level’ information field is determined based on the total number of frames in each video frame interval. For example, 3 or more bits must be assigned to the ‘max_level’ information in the case where each video frame interval is composed of 32 frames.

The data stream encoded in the method described above is transmitted by wire or wirelessly to a decoding device or is delivered via recording media. The decoding device restores the original video signal of the encoded data stream according to the method described below.

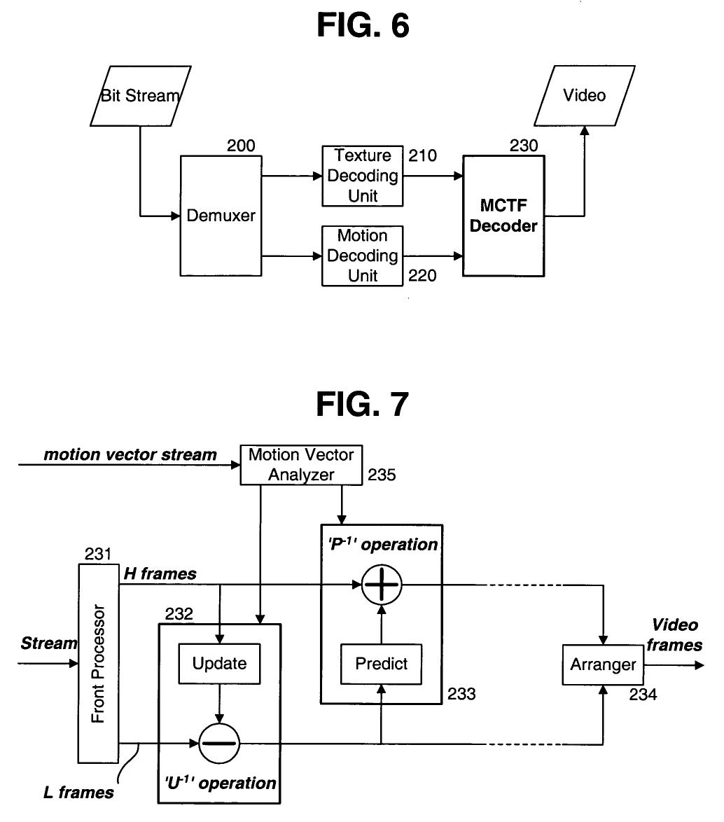

FIG. 6 is a block diagram of a device for decoding a data stream encoded by the device of FIG. 1. The decoding device of FIG. 6 includes a demuxer (or demultiplexer) 200, a texture decoding unit 210, a motion decoding unit 220, and an MCTF decoder 230. The demuxer 200 separates a received data stream into a compressed motion vector stream and a compressed macroblock information stream. The texture decoding unit 210 restores the compressed macroblock information stream to its original uncompressed state. The motion decoding unit 220 restores the compressed motion vector stream to its original uncompressed state. The MCTF decoder 230 converts the uncompressed macroblock information stream and the uncompressed motion vector stream back to an original video signal according to an MCTF scheme.

The MCTF decoder 230 includes, as an internal element, an inverse filter as shown in FIG. 7 for restoring an input stream to its original frame sequence.

The inverse filter of FIG. 7 includes a front processor 231, an inverse updater 232, an inverse predictor 233, an arranger 234, and a motion vector analyzer 235. The front processor 231 divides an input stream into H frames and L frames, and analyzes information in each header in the stream. The inverse updater 232 subtracts pixel difference values of input H frames from corresponding pixel values of input L frames. The inverse predictor 233 restores input H frames to frames having original images using the H frames and the L frames from which the image differences of the H frames have been subtracted. The arranger 234 interleaves the frames, completed by the inverse predictor 233, between the L frames output from the inverse updater 232, thereby producing a normal video frame sequence. The motion vector analyzer 235 decodes an input motion vector stream into motion vector information of each block and provides the motion vector information to the inverse updater 232 and the inverse predictor 233. Although one inverse updater 232 and one inverse predictor 233 are illustrated above, a plurality of inverse updaters 232 and a plurality of inverse predictors 233 are provided upstream of the arranger 234 in multiple stages corresponding to the MCTF encoding levels described above.

The front processor 231 analyzes and divides an input stream into an L frame sequence and an H frame sequence. In addition, the front processor 231 uses information in each header in the stream to notify the inverse updater 232 and the inverse predictor 233 of which frame or frames have been used to produce macroblocks in the H frame.

Specifically, if an ‘open_structure’ information field included in the header area of a current GOP in the stream is activated, the front processor 231 provides information to the inverse updater 232 and the inverse predictor 233. This information allows the inverse updater 232 and the inverse predictor 233 to use frames in the previous GOP and frames in the next GOP when performing inverse update and prediction operations of the current GOP. This information provided to the inverse updater 232 and the inverse predictor 233 includes information about frames in the previous and/or next video frame intervals that have been used to produce macroblocks in the H frame.

When the ‘open_structure’ information field included in the header area of the current GOP is activated, the front processor 231 also provides the value in the ‘max_level’ information field, which indicates the level from which the inverse updater 232 and the inverse predictor 233 may additionally use frames in the adjacent GOPs when performing inverse update and prediction operations, to the inverse updater 232 and the inverse predictor 233.

If the ‘broken’ information field is activated when the ‘open_structure’ information field is activated, the front processor 231 also provides information that prevents the inverse updater 232 and the inverse predictor 233 from using frames in at least one adjacent GOP (particularly, frames in the next GOP) when performing inverse and prediction operations of the current GOP.

When an ‘open_structure’ information field of the previous GOP is deactivated or when the ‘open_structure’ information field of the previous GOP is activated but a ‘broken’ information field is activated, the front processor 231 prevents the inverse updater 232 and the inverse predictor 233 from using frames in the previous GOP when performing inverse update and prediction operations of the current GOP even if an ‘open_structure’ information field included in the header of the current GOP is activated.

The inverse updater 232 performs the operation of subtracting an image difference of an input H frame from an input L frame in the following manner. For each macroblock in an input H frame, the inverse updater 232 confirms a reference block present in an L frame prior to or subsequent to the H frame or two reference blocks present in two L frames prior to and subsequent to the H frame, using a motion vector provided from the motion vector analyzer 235, and performs the operation of subtracting pixel difference values of the macroblock of the input H frame from pixel values of the confirmed one or two reference blocks.

The inverse predictor 233 may restore an original image of each macroblock of the input H frame by adding the pixel values of the reference block, from which the image difference of the macroblock has been subtracted in the inverse updater 232, to the pixel difference values of the macroblock.

The above decoding method restores an MCTF-encoded data stream to a complete video frame sequence. In the case where the estimation/prediction and update operations have been performed for a video frame interval N times (N levels) in the MCTF encoding procedure described above, a video frame sequence with the original image quality is obtained if the inverse estimation/prediction and update operations are performed N times in the MCTF decoding procedure. However, a video frame sequence with a lower image quality and at a lower bitrate is obtained if the inverse estimation/prediction and update operations are performed less than N times. Accordingly, the decoding device is designed to perform inverse estimation/prediction and update operations to the extent suitable for its performance.

In another embodiment, the ‘open_structure’ information field and the ‘broken’ information field may be combined to define a 2-bit ‘structure’ information field. This information field may be conveniently defined when encoding consecutive frame intervals disconnected due to screen switching or due to editing in units of video frame intervals and may also be conveniently referred to when decoding the disconnected frame intervals.

The value of the ‘structure’ information field is set to ‘00b’ in the case where the current video frame interval is encoded using the closed structured MCTF scheme without using frames in its adjacent frame intervals; the value of the ‘structure’ information field is set to ‘10b’ in the case where the current video frame interval is encoded using the open structured MCTF scheme while additionally using only frames in its previous frame interval; the value of the ‘structure’ information field is set to ‘01b’ in the case where the current video frame interval is encoded using the open structured MCTF scheme while additionally using only frames in its next frame interval; and the value of the ‘structure’ information field is set to ‘11b’ in the case where the current video frame interval is encoded using the open structured MCTF scheme while additionally using frames in both the previous and next frame intervals. The ‘max_level’ information field is effective only when the value of the ‘structure’ information field is ‘01b’, ‘10b’, or ‘11b’.

The case where the value of the ‘structure’ information field is ‘00b’ corresponds to the case where the ‘open_structure’ information field is deactivated in the previous embodiment, and the case where the value of the ‘structure’ information field is ‘11b’ corresponds to the case where the ‘open_structure’ information field is activated and the ‘broken’ information field is deactivated in the previous embodiment.

If a scene change occurs due to editing in units of video frame intervals, the value of the ‘structure’ information field of the previous interval is set to ‘10b’, and the value of the ‘structure’ information field of the next interval is set to ‘01b’.

Defining the ‘structure’ information field in this manner makes it possible to determine, based on the ‘structure’ information field included in the header of the current GOP, whether to use frames in the previous and/or next GOPs when decoding frames in the current GOP, without reference to information fields defined for the previous GOP.

The decoding device described above may be incorporated into a mobile communication terminal or the like or into a recording media playback device.

As is apparent from the above description, a method for encoding/decoding video signals according to the present invention has the following advantages. Frames in video frame intervals adjacent to the current frame interval may be additionally used when encoding/decoding video signals of the current frame interval in a scalable MCTF scheme, thereby reducing degradation of the image quality of frames at the boundaries of video frame intervals.

In addition, the number of frames, which may be referred to, is increased to improve predictive performance, thereby increasing compressing performance.

Although the example embodiments of the present invention have been disclosed for illustrative purposes, those skilled in the art will appreciate that various modifications, additions and substitutions are possible, without departing from the scope and spirit of the invention.

1. A method of decoding an encoded video signal by motion compensated temporal filtering (MCTF), comprising:
decoding a frame in a current frame interval based on at least one frame in at least one adjacent frame interval, the adjacent frame interval being adjacent to the current frame interval.

2. The method of claim 1, wherein the frame interval and adjacent frame interval each include a group of frames.

3. The method of claim 2, wherein the group of frames in the adjacent frame interval includes at least one H frame.

4. The method of claim 2, wherein the group of frames in the adjacent frame interval includes at least one L frame.

5. The method of claim 1, wherein the adjacent frame interval is a previous frame interval.

6. The method of claim 5, wherein the decoding step decodes a frame in the current frame interval based on at least one frame in the previous frame interval if no scene change occurs between the previous frame interval and the current frame interval.

7. The method of claim 5, further comprising:
confirming, from information in the current frame interval, that the current frame interval was encoded using at least one frame from at least one adjacent frame interval; and
performing the decoding step if the conf g step confirms that the current frame interval was encoded using at least one frame from at least one adjacent frame interval.

8. The method of claim 7, wherein the information is in a header of the current frame interval.

9. The method of claim 5, wherein the decoding step uses at least one H frame of the previous frame interval to decode the frame of the current frame interval.

10. The method of claim 5, wherein
the previous frame interval include frames at different encoded levels; and
the decoding step uses at least one frame in the previous frame interval up to a specific encoded level to decode the frame of the current frame interval.

11. The method of claim 10, further comprising:
confirming the specific encoded level from information in the current frame interval.

12. The method of claim 10, further comprising:
confirming, from information in the current frame interval, whether an adjacent frame interval was used to encode the current frame interval and the specific encoded level.

13. The method of claim 1, wherein the adjacent frame interval is a subsequent frame interval.

14. The method of claim 13, wherein the decoding step decodes a frame in the current frame interval based on at least one frame in the subsequent frame interval if no scene change occurs between the current frame interval and the subsequent frame interval.

15. The method of claim 13, further comprising:
confirming, from information in the current frame interval, that the current frame interval was encoded using at least one frame from at least one adjacent frame interval; and
performing the decoding step if the confirming step confirms that the current frame interval was encoded using at least one frame from at least one adjacent frame interval.

16. The method of claim 15, wherein the information is in a header of the current frame interval.

17. The method of claim 13, wherein the decoding step uses at least one L frame of the subsequent frame interval to decode the frame of the current frame interval.

18. The method of claim 13, wherein
the subsequent frame interval include frames at different encoded levels; and
the decoding step uses at least one frame in the subsequent frame interval up to a specific encoded level to decode the frame of the current frame interval.

19. The method of claim 18, further comprising:
confirming the specific encoded level from information in the current frame interval.

20. The method of claim 18, further comprising:
confirming, from information in the current frame interval, whether an adjacent frame interval was used to encode the current frame interval and the specific encoded level.

21. The method of claim 20, wherein the confirming step further confirms whether the subsequent frame interval was used to encode the current frame interval from the information.

22. The method of claim 20, wherein the decoding step decodes the current frame interval using at least one frame from the subsequent frame interval if the confirming step confirms that an adjacent frame interval was used to encode the current frame interval and the subsequent frame interval was used to encode the current frame interval.

23. The method of claim 20, wherein the decoding step does not decode the current frame interval using at least one frame from the subsequent frame interval if the confirming step confirms that an adjacent frame interval was used to encode the current frame interval and the subsequent frame interval was not used to encode the current frame interval.

24. The method of claim 1, wherein the decoding step decodes a frame in the current frame interval based on at least one frame in the adjacent frame interval if no scene change occurs between the adjacent frame interval and the current frame interval.

25. The method of claim 1, further comprising:
confirming, from information in the current frame interval, that the current frame interval was encoded using at least one frame from at least one adjacent frame interval; and
performing the decoding step if the confirming step confirms that the current frame interval was encoded using at least one frame from at least one adjacent frame interval.

26. The method of claim 25, wherein the information is in a header of the current frame interval.

27. The method of claim 1, wherein the decoding step uses at least one H frame of the adjacent frame interval to decode the frame of the current frame interval.

28. The method of claim 1, wherein the decoding step uses at least one L frame of the adjacent frame interval to decode the frame of the current frame interval.

29. The method of claim 1, wherein
the adjacent frame interval include frames at different encoded levels; and
the decoding step uses at least one frame in the adjacent frame interval up to a specific encoded level to decode the frame of the current frame interval.

30. The method of claim 29, further comprising:
confirming the specific encoded level from information in the current frame interval.

31. The method of claim 29, further comprising:
confirming, from information in the current frame interval, whether an adjacent frame interval was used to encode the current frame interval and the specific encoded level.

32. The method of claim 1, wherein the current frame interval includes frames at different encoded levels, and the decoding step decodes a frame at one of the different encoded levels.

33. A method of decoding a video signal by motion compensated temporal filtering (MCTF), comprising:
decoding a frame in a current frame interval selectively based on at least one frame in at least one adjacent frame interval, the adjacent frame interval being adjacent to the current frame interval.

34. A method of encoding a video signal by motion compensated temporal filtering (MCTF), comprising:
encoding a frame in a current frame interval based on at least one frame in at least one adjacent frame interval, the adjacent frame interval being adjacent to the current frame interval.

35. A method of encoding a video signal by motion compensated temporal filtering (MCTF), comprising:
adding information to an encoded current frame interval, the information indicating whether at least one frame of an adjacent frame interval was used to encode the encoded current frame interval.
